(19) United States
(12) Patent Application Publication
(10) Pub. No.: US 2004/0260835 A1
(43) Pub. Date: Dec. 23, 2004

(54) Automotive internet radio system

(76) Inventors: Douglas L. Welk, Rossville, IN (US); Keenan A. Estese, Kokomo, IN (US); Quyen N. Tran, Kokomo, IN (US)

Correspondence Address: DELPHI TECHNOLOGIES, INC., M/C 480-410-202, PO BOX 5052, TROY, MI, 48007, US

(21) Appl. No.: 10/686,218

(22) Filed: Oct. 15, 2003

Related U.S. Application Data
(60) Provisional application No. 60/480,632, filed on Jun. 23, 2003.

(51) Int. Cl. G06F 15/16

(52) U.S. Cl. 709/245

(57) ABSTRACT

The present invention includes an address accessible information transmission system that enables a vehicle occupant to listen and/or view address accessible information accessible on the Internet through the vehicle's entertainment system. The address accessible information transmission system includes a server capable of obtaining the address accessible information, and a receiver in communication with the server, the receiver capable of utilizing the address to access the address accessible information, and providing the address accessible information to the vehicle's entertainment system. The receiver includes a head unit having an interface that enables the vehicle occupant to select the address accessible information.

This application claims the benefit of U.S. Provisional Patent Application No. 60/480,632 filed on Jun. 23, 2003.

### TECHNICAL BACKGROUND

The invention relates generally to automotive entertainment systems.

### BACKGROUND OF THE INVENTION

For years, consumers have been engaged in the in-vehicle use of AM/FM radios, tape players, CD players and, more recently, DVD players in order to provide themselves with entertainment while occupying their vehicles. One of the more recent additions to in-vehicle entertainment systems has been the inclusion of the Satellite Digital Audio Radio System (“SDARS”). SDARS enable a vehicle occupant to enjoy satellite radio programming, including, e.g., music and news. Only two providers of satellite radio currently exist in the market today, and while each provider provides subscribing consumers with upwards of one-hundred (100) channels, consumers are somewhat limited in their program selection.

The MP3 audio compression format, in the meanwhile, has enabled the development of Internet radio broadcasts. Currently, there are thousands of radio stations worldwide that broadcast audio data on the Internet. There are also several thousand audio tracks, as well as other media, available on the Internet on an “on-demand” basis. Because a relatively high-speed connection to the Internet has typically been needed to take advantage of the Internet radio broadcasts and on-demand audio tracks, the primary receivers for these broadcasts traditionally have been desktop computers or laptop personal computers.

As may be understood from the above-mentioned technologies, a problem has developed in the art. While SDARS is available for consumer use in vehicles, the consumers only have one-hundred or so programs from which to choose. With the use of Internet radio broadcasts, however, consumers have thousands of broadcast programs from which to choose, as long as the consumer is located next to their desktop or laptop computer with an Internet connection. In a fast-paced society where people are constantly on the go, consumers constantly find themselves between locations in which it is possible to use their desktop and laptop computers. What is needed in the art is a way of providing a consumer with access to Internet radio broadcasts when the consumer is away from her computers.

### SUMMARY OF THE INVENTION

The present invention provides an address accessible information transmission system including a receiver for use in a vehicle to enable the vehicle's occupant to access Internet radio broadcasts and on-demand audio tracks while the consumer is in her vehicle. In one embodiment of the present invention, the address accessible information transmission system includes a server maintaining a specified address for address accessible information, and a receiver in communication with the server, the receiver capable of retrieving the specified address, utilizing the address to access the address accessible information, and providing the address accessible information to the vehicle entertainment system.

In this embodiment of the present invention, the desired address accessible information is associated with an URL. The URL points to address accessible information on the Internet, including Internet radio broadcasts. The URL is stored on the server, may be associated with a text string and is accessible to a consumer using the receiver of the present invention.

In another embodiment of the present invention, the address accessible information transmission system includes a server capable of obtaining the address accessible information, and a receiver in communication with the server, the receiver capable of both identifying desired address accessible information to the server and providing the address accessible information to the vehicle entertainment system.

In still another embodiment of the present invention, a receiver is provided for use with the address accessible information transmission system, the receiver including means for communicating with a server maintaining user data, means for retrieving the user data, the user data including the specified address, and means for both utilizing the specified address to access the address accessible information and providing the address accessible information to a vehicle entertainment system. The receiver includes a head-unit containing a conventional radio-like interface (i.e., tuner controls) that enables the consumer to scroll through the URLs or text strings in a sequence to locate and select the Internet broadcasts of her choice.

In yet another embodiment of the present invention, a method of delivering the address accessible information to a vehicle entertainment system is provided, the method including the steps of providing a receiver, and utilizing the receiver to perform the steps of retrieving the specified address, accessing the address accessible information using the specified address, the address accessible information streamed from an information provider server, and providing the address accessible information to the vehicle entertainment system.

### BRIEF DESCRIPTION OF THE DRAWINGS

The above-mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a perspective view of the receiver of the present invention;

FIG. 2 is a schematic view of the address accessible information system of the present invention;

FIG. 3A is a front perspective view of a first head unit capable of use with the receiver of the present invention shown in FIG. 1;

FIG. 3B is a front perspective view of a second head unit capable of use with the receiver of the present invention shown in FIG. 1;

FIG. 4 is a diagrammatic view of the address accessible information transmission system of the present invention;

FIG. 5 is a flowchart illustrating the consumer's role in utilizing the address accessible information transmission system of the present invention, including the functionality of the system receiver;

FIG. 6 is a flowchart illustrating the consumer's role in utilizing the address accessible information transmission system of the present invention, including the functionality of an alternative embodiment of the system receiver; and

FIG. 7 is a flowchart illustrating the consumer's role in utilizing an alternative embodiment of the address accessible information transmission system of the present invention, including the functionality of the system receiver.

Corresponding reference characters indicate corresponding parts throughout the several views. Although the drawings represent embodiments of the present invention, the drawings are not necessarily to scale and certain features may be exaggerated in order to better illustrate and explain the present invention. The exemplifications set out herein illustrate embodiments of the invention in several forms and such exemplification is not to be construed as limiting the scope of the invention in any manner.

### DESCRIPTION OF INVENTION

The embodiments disclosed below are not intended to be exhaustive or limit the invention to the precise forms disclosed in the following detailed description. Rather, the embodiments are chosen and described so that others skilled in the art may utilize their teachings.

In the following description, several terms which are used frequently have specialized meanings in the present context. The terms “network”, “local area network”, “LAN”, “wide area network”, or “WAN” mean two or more computers which are connected in such a manner that messages may be transmitted between the computers. For instance, one type of communications network may be a globally accessible information interchange network, for example, the Internet. In this type of global network, millions of computer systems are connected and data is transmitted over the network between multiple computer systems.

In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment.

The term “Browser” refers to a program which is not necessarily apparent to the user, but which is responsible for transmitting messages between the workstation and the network server and for displaying and interacting with the network user. Browsers are designed to utilize a communications protocol for transmission of text and graphic information over a world wide network of computers, namely the “World Wide Web” or simply the “Web.” The Web is a means of accessing information over the Internet. A Uniform Resource Locator (“URL”) is hereinafter defined as the global address of any “address accessible information” available on the Web or Internet such address accessible information including, but not limited to, audio data, video data, text data, documents, files, playlists (defined infra), images, pictures, video game data, web cam data, etc.

Examples of Browsers compatible with the present invention include the Navigator program by Netscape Corporation and the Internet Explorer by Microsoft Corporation (Navigator and Internet Explorer are trademarks of their respective owners). Although the following description details such operations in terms of a graphic user interface of a Browser, the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

Most computer-based audio data file management programs allow the user to create and edit “playlists” that can then be downloaded and used for playing a select sequence of audio data files. One such form of playlist typically associated with MP3 audio data files is known as a M3U list. A M3U playlist consists simply of a text file containing a numbered sequential list of paths or locations of data audio files included in the playlist. Thus, a playlist created on a computer and downloaded to a receiving device may be used to selectively play a sequence of audio data files that are contained in the data storage of the receiving device. Additionally, the M3U file format includes only the file location or path information and a comment field, and the format does not contain other audio data file information. Other playlist file formats exist as well, for example, a proprietary playlist file format such as the one used in an exemplary embodiment of the present invention.

“Streaming” is a method of making audio, video and other forms of address accessible information available to an end user from a remote location in real-time over the Internet. After accessing the streaming address accessible information from the remote location, the end user receives the information in the form of data packets. A buffer in the end user's receiving device collects the data packets as they arrive at the device. The address accessible information may be played as soon as the buffer collects the minimum amount of data packets enabling the address accessible information to be played. The receiving device then discards the data packets as they are used.

Automotive vehicle entertainment systems have long been a part of the equipment available to consumers. Many types of entertainment systems have been made available, from the first AM tuners to the more sophisticated Rear Seat Audio Video (“RSAV”) systems and SDARS. The advent of the MP3 audio compression format sparked the development of Internet radio broadcasts, and coupled with the development and deployment of high-speed networks, the radio broadcasts may be received in a moving vehicle with the use of a receiver designed for use in the vehicle. The present invention provides such a receiver. Because many vehicle occupants spend a majority of their time listening to radio broadcasts while in their vehicle, the receiver's ability to receive and play Internet broadcasts greatly adds to the occupant's enjoyment of and satisfaction with their vehicle entertainment system.

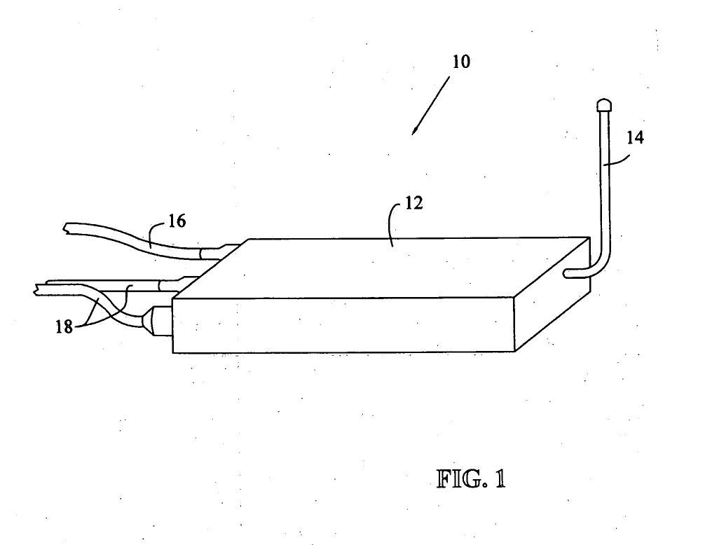

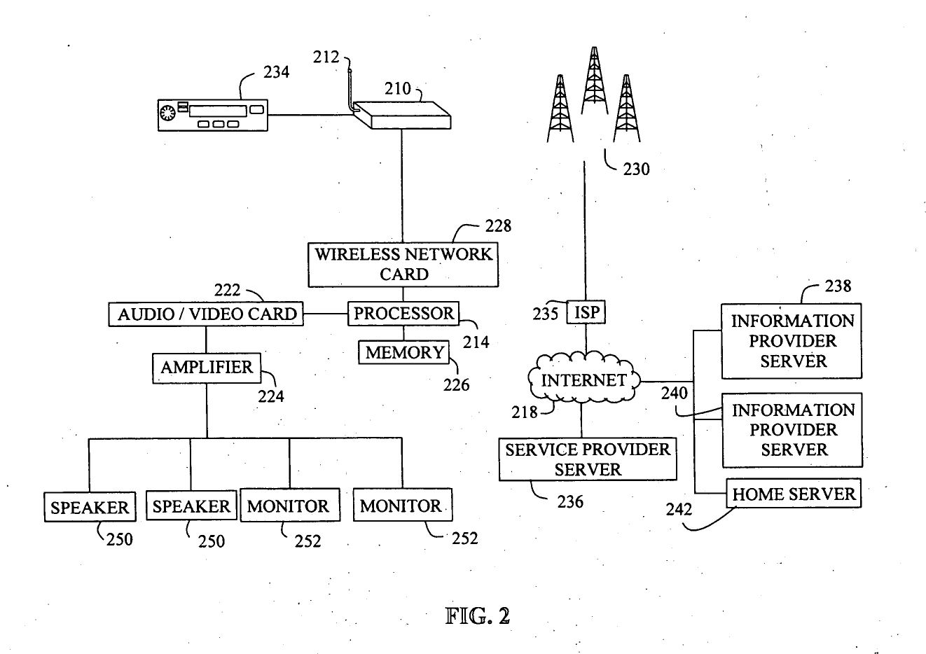

In one embodiment of the present invention, an address accessible information system for delivering address accessible information to a vehicle entertainment system includes a server maintaining one or more URLs pointing to address accessible information, and a receiver in communication with the server, the receiver capable of retrieving the URLs, using the URLs to access the desired address accessible information and providing the information to the vehicle entertainment system. The receiver is shown in FIG. 1. Receiver 210 includes housing 12, wireless antenna 14, control connector 16 and audio/video outputs 18. Referring to FIG. 2, the internal components of receiver 210 include processor 214, audio/video card 222, amplifier 224, wireless network card 228 for interfacing with networks, e.g., wireless network 230 and the Internet by way of Internet service provider 235, and memory 226 for the storage of audio data, video data, configuration data, playlist information, etc. The configuration data may include the URLs of address accessible information, corresponding user-defined text strings and presets, and radio station subscriber information. Computer processor 214 includes software or firmware that enables receiver 210 to play streamed, stored and/or downloaded address accessible information, respond to the controls of head unit 234, operate network card 228 and manage network protocols to enable receiver 210 to communicate and interface with wireless network 230, the Internet, servers 236, 238, 240 and home server 242.

In an exemplary embodiment, computer processor's 214 software/firmware includes a Linux operating system, and the software/firmware enabling receiver 210 to play address accessible information may support different information formats, e.g., MP3, Microsoft Corp.'s MS Audio, Liquid Audio (LIQUID AUDIO is a registered trademark of Liquid Audio, Inc. of Redwood City, Calif. 94063), ePAC (ePAC is a registered trademark of Lucent Technologies, Inc. of Murray Hill, N.J. 07974), A2B Music (A2B MUSIC is a registered trademark of AT&T Corp. of New York, N.Y. 10003), Real Audio's G2 (REALAUDIO is a registered trademark of Progressive Networks, Inc. of Seattle, Wash. 98104), DivX (DIVX is a registered trademark of DivXNctworks, Inc. of San Diego, Calif. 92121), Quicktime movies (QUICKTIME is a registered trademark of Apple Computer, Inc. of Cupertino, Calif. 95014), Microsoft Corp.'s AVI movies, Windows Media (WINDOWS MEDIA is a registered trademark of Microsoft. Corp. of Redmond, Wash. 98052), and others. “MP3” is an abbreviation for MPEG audio layer 3, i.e., an encoding scheme for the compression of audio signals. The software/firmware enabling receiver 210 to play address accessible information in these formats may include, for example, Microsoft Corp.'s Windows Media Player and RealNetworks, Inc.'s RealOne (REALONE is a registered trademark of RealNetworks, Inc. of Seattle, Wash. 98121).

Again referring to FIG. 2, receiver 210 uses antenna 212 to receive address accessible information in the form of analog radio frequency (“RF”) signals from wireless network 230. In an exemplary embodiment, antenna 212 is attached to wireless network card 228, and wireless network card 228 amplifies the RF signals, reduces the signals into intermediate frequency (“IF”) signals, and converts the analog IF signals to digital signals, which are processed by computer processor 214. In another embodiment of the present invention, the functionality of wireless network card 228 is implemented in a circuit board including a pre-amplifier, a down converter and an analog/digital (“A/D”) converter. Processor 214 sends/captures Internet protocol (“IP”) packets from memory 226, which processor 214 shares with network card 228. Processor 214 sends/receives and extracts/decodes control and address accessible information from the IP packets. Audio/video card 222 receives the address accessible information from processor—214 and translates the information into audio and/or video signals before transmitting the information to audio/video amplifier 224. Receiver 210 then uses audio/video outputs 18 (FIG. 1) in transmitting the address accessible information to speakers 250 and/or video display monitor 252 of the vehicle entertainment system for translation into audible sound and/or visual pictures. Control connector 16 (FIG. 1) connects receiver 210 to head unit 234 so that the head unit 234 controls may be manipulated by the vehicle's occupant to engage the functionality of receiver 210.

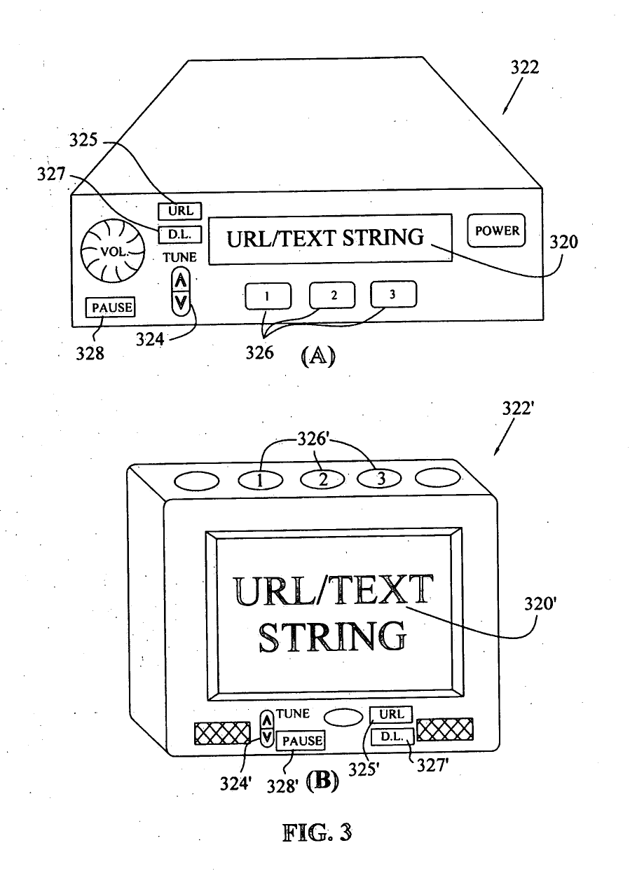

As described above, control connector 16 (FIG. 1) connects receiver 210 to head unit 234 of FIG. 2. Shown in greater detail in FIGS. 3A and 3B, head unit 322, 322′ may be any head unit used in vehicles to control the vehicle's audio and/or visual system, including the standard CD-changer enabled unit displayed in FIG. 3A or the display monitor displayed in FIG. 3B, which is used by vehicle occupants to view television programs, DVD movies and/or view video games. Head unit 322, 322′ may also be a combination of a CD-changer enabled unit and a display monitor. Head unit 322, 322′ of FIGS. 3A and 3B includes tuner control 324, 324′. As it is traditionally used, tuner control 324, 324‘enables a vehicle’s occupant to tune up and down to different radio stations and or television stations, depending on the functionality of the head unit. For purposes of the present invention, however, tuner control 324, 324‘is used to enable the vehicle’s occupant to scroll up and down through URLs associated with address accessible content desired by the occupant.

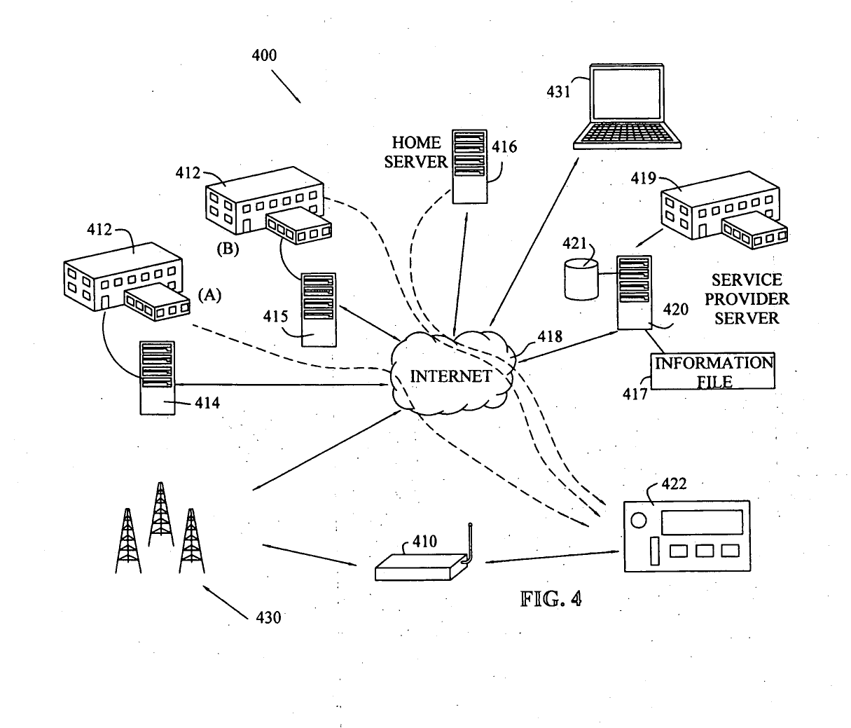

Address accessible information transmission system 400 of the present invention is shown in FIG. 4. Address accessible transmission system 400 includes network 418. In an exemplary embodiment of the present invention, network 418 is the Internet. System 400 also includes service provider server 420, information providers 412a, 412b wireless network 430, receiver 410 and head unit 422. Servers 414, 415, 416, 420 communicate with Internet 418 by way of a conventional Internet connection, e.g., dial-up modem, cable modem, digital consumer line (“DSL”), LAN with a TCP/IP routing to Internet 418, etc. Wireless receiver 410 uses RF signals to communicate with wireless network 430, which in turn uses RF or other connection means to communicate with Internet 418. Wireless network 430 may include any network using mobile broadband technology, including, e.g., Flarion's Flash-OFDM™ technology (FLASH-OFDM is a registered trademark of Flarion Technologies, Inc. of Bedminster, N.J. 07921), Sprint PCS's wireless network (SPRINT PCS is a registered trademark of Sprint PCS of Kansas City, Mo. 64114) and MeshNetworks' MEA™ network (MEA is a registered trademark of MeshNetworks, Inc. of Maitland, Fla. 32751). Receiver 410 may communicate with any of servers 414, 415, 416, 420 via wireless network 430 and Internet 418. Accordingly, and as represented by the dashed lines of FIG. 4, the operator of head unit 422 has a virtual connection to each of Internet resources 414, 415, 416, all of which are capable of providing address accessible information to the operator of head unit 322, 322′.

Information providers 412a, 412b make address accessible information available to consumers on Internet 418. Address accessible information providers 412a, 412b may include Internet radio stations, Internet television stations, Internet video rental services, Internet game rental services or any other entity capable of providing streaming or downloadable address accessible information on Internet 418. Consumers are also able to make address accessible information available to themselves or others on Internet 418 by storing such information on home server 416. Home server 416 may be used to supply a consumer with access to her “home” or “office” musical and/or video address accessible information. The address accessible information streamed from servers 414, 415 or stored on home server 416 is typically stored in a compressed format to reduce both the necessary storage space and the bandwidth required for transmitting the address accessible information to receiver 410. Examples of such compressed formats include the MPEG formats developed by the Moving Pictures Expert Group.

Again referring to FIG. 4, address accessible information providers. 412a, 412b may provide radio broadcasts on Internet 418, including, but not limited to, news, music, sports, business, etc. Address accessible information providers 412a, 412b may also broadcast Internet video, e.g., television shows, news, sports, movies, webcams, video games, etc. In broadcasting a particular genre of music on Internet 418, for example, information provider 412a may compile a large number of jazz songs that information provider 412a desires to make available oil Internet 418 to consumers whom “tune-in” to, or access the URL of, the broadcast. In broadcasting this address accessible information, information provider 412a uses conventional streaming audio software to broadcast the songs from server 414. At that point, any consumer with software capable of playing Internet audio streams can tune-in and listen to the audio stream. Similarly, information provider 412b may broadcast television shows from server 415.

Address accessible information transmission system 400 also includes service provider server 420. Service provider server 420 may be maintained by service provider 419. Any consumer subscribing to service provider's 419 service may have an account on server 420 containing the consumer's profile information stored in information file 417. Information file 417 is unique to each subscriber, and in addition to server 420, service provider 419 may maintain one or more databases of information files (depending on the number of subscribers that subscribe to service provider's 419 services). The consumer's profile may include the following: URLs (pointing to address accessible information provided by information providers 412a, 412b, home server 416, etc.) that the consumer wants to have available in her vehicle; a playlist of URLs to be played in sequential order; text strings associated with the stored URLs (e.g., “BEETHOVEN” may be the text string associated with the URL “http://www.hits.com/stream/master.abc”) as will be described; identification of which URLs or text strings are associated with presets (e.g., “BEETHOVEN” may be associated with preset 1 while “MOZART” may be associated with preset 2); additional URLs for address accessible information that service provider 419 believes may be of interest to the consumer, and additional features available for purchase and download from service provider 419. Service provider server 420 also maintains all configuration data necessary for receiver 410 to interface with the Internet, e.g., network protocol information, subscriber information, servers 414, 415, 416 access information, information enabling server 420 to recognize receiver 410, etc.

Service provider 419 may provide access to consumer accounts on server 420 through a web site or software provided to the consumer by service provide 419. Thus, a consumer with an account with service provider 419 may use computer 431, which is capable of communicating with service provider server 420 over Internet 418, to access and manage her account on service provider server 420. By utilizing a conventional web browser or software provided by service provider 419 to access her account, the consumer may identify radio stations, television stations, or other address accessible information resources on Internet 418 that interests the consumer. The consumer may then create a personalized list of URLs pointing to those address accessible information resources that she wishes to access from her vehicle. The consumer may also use her account to add additional address accessible information resource URLs to the list, remove address accessible information resource URLs from the list, assign text strings to URLs, set presets 326, 326′ to particular URLs with associated text strings, set up her profile information and purchase additional features and functions for downloads provided by service provider 419.

A consumer may choose to access address accessible information maintained by the consumer for personal use. Referring to FIG. 4, the consumer may have created and stored address accessible information on home server 416, for example, a file such as a MP3 file or a playlist. As long as the consumer makes the file accessible on Internet 418, the consumer may include the URL pointing to the file to her custom list of URLs. The consumer may also associate a text string with the URL, e.g., the consumer may associate the text string “Classics” with the URL “http://205.188.234.38:8000” pointing to her playlist on home server 416.

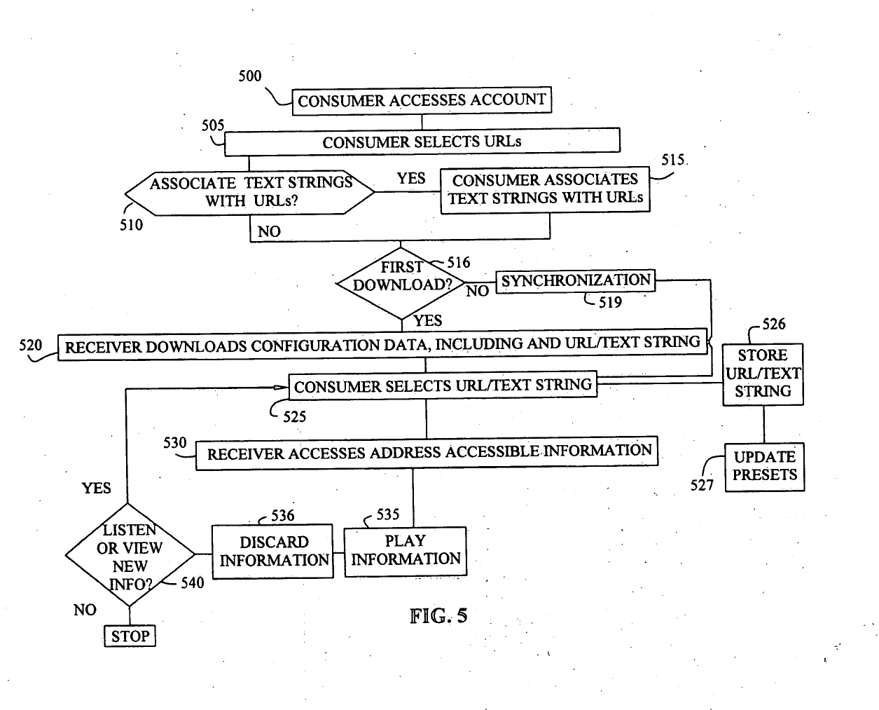

The flowchart of FIG. 5 illustrates the consumer's role in utilizing address accessible information transmission system 400 (FIG. 4) as well as the functionality of an exemplary embodiment of the receiver of the present invention. Service provider 419 or a commercial electronics vendor may provide receiver 410 to a consumer for installation in the consumer's vehicle. Upon subscribing to service provider's 419 services, the consumer is given access materials (e.g., consumer software, registration number, account information, user name/password, etc.) enabling the consumer to use any computer 431 to access service provider server 420 and an accompanying web site. Service provider 419 may compile and store URLs in database 421. Other sources, e.g., indexing web sites or information providers 412a, 412b, may store thousands of URLs from which the consumer may select. In other embodiments of the present invention, the consumer may simply choose one or more URLs from many different sources instead of obtaining all of her URLs from one location. Each of the URLs point to an address accessible information resource such as an Internet radio station, television station, gaming station, or other address accessible information resource from which address accessible information may be retrieved.

The consumer firsts uses computer 431 to access her account on service provider server 420 at 500. At 505 the consumer may view and select URLs maintained in database 421, or provided by other services via Internet 418, to create a list of URLs. At 510 the consumer has the choice of associating her selected URLs with descriptive text strings. If the consumer chooses to do so, she may associate text strings with her chosen URLs at 515. For example, the consumer may associate the test string “Storming80s” with the URL “http://144.240.28.146:8000:” Service provider server 420 then stores the consumer's selected URLs and the associated text strings.

The consumer may be riding in her vehicle when she determines that she wants to listen to jazz music. Remembering that she added the URL of an Internet radio jazz station to her URL list, the consumer may use head unit 322 to access the URL. Referring again to FIG. 3A, the consumer may utilize her URL list by selecting URL control button 325, by powering head unit 322, starting her vehicle, or engaging any other appropriately programmed playlist activation mechanism. Receiver 410 determines at step 516 whether the consumer's configuration data has been downloaded before or whether this is the first download of the data. If it is the first download, receiver 410 downloads the configuration data from service provider server 420 at step 520, the configuration data including the URL list created by the consumer. If the configuration data already has been downloaded at some point in time, receiver 410 synchronizes the configuration data at step 519 with the consumer's configuration data stored on service provider server 420 in information file 417. After receiver 410 synchronizes the URL list at 519 or downloads the URL list at 520, the consumer at 525 may select the address accessible information for playback by using tuner control 324 to sequentially move up or down through the downloaded URLs. The URLs may be viewed on head unit display panel 320. For example, the consumer may scroll through the URLs and see, e.g., “http://144.240.28.146:8000”, “http://205.188.234.38:8000”, or “http://www.hits.com/stream/master.abc.” If the consumer has associated text strings with the URLs, the consumer may scroll through the text strings and see, e.g., “Storming80s”, “Classics” and “BEETHOVEN”, each of which are associated with an URL stored on service provider server 420.

When the consumer finds the URL/text string for the desired Internet jazz radio station, e.g., address accessible information provider 412a, receiver 410 accesses the address accessible information streaming from web server 414 at 530. At 535, receiver 410 plays the streaming address accessible information through the vehicle's speakers, and at 536, receiver 410 discards the address accessible information after it is played.

Receiver 410 includes play and pause capability as well. For example, as receiver 410 is playing the address accessible information through the vehicle's speakers, the consumer may need to pause receiver 410 for a moment. Because receiver 410 is using the consumer's selected URL to access the streaming address accessible information, information provider 412a continues to stream the information and receiver 410 continues to receive the information, even if receiver's 410 play feature is paused. Accordingly, if the consumer uses pause button 328 (FIG. 3A) to pause the streaming address accessible information, the consumer may resume listening to the address accessible information upon her un-pausing the play feature of receiver 410. Since information provider 412a is streaming the address accessible information, receiver 410 will pick up and resume playing the address accessible information not from the point in which it was paused, but at whatever point in the address accessible information in which the information is currently being streamed. In the same way, if the consumer turns off her vehicle, when the vehicle is powered and receiver 410 resumes playing address accessible information, receiver 410 picks up the address accessible information at the point in the information in which the information is currently being streamed.

The consumer may also use any of preset buttons 326 of head unit 322 (FIG. 3A) to store the URL/text string associated with the jazz station in receiver's 410 preset memory at 526. Presets 326 enable the user of head unit 322 to store in memory 226 (FIG. 2) URLs or text strings pointing to the user's favorite or most accessed address accessible information so that the URL/text string does not have to be located every time receiver 410 and head unit 322 is used. Each time that a URL/text string is stored in receiver's 410 preset memory at 526, receiver 410 synchronizes the configuration data by sending a message to service provider server 420 to update the presets in the configuration data. For example, a user of head unit 322 may set preset 326-1 to URL “http://206.199.222.2:9000”, or an associated text string, e.g., “POP1”, and set preset 326-2 to URL “http://206.199.333.9000”, or an associated text string, e.g, “POP2”. Accordingly, every time the user wants to access address accessible information located at the URL “http://206.199.222.2:9000”, she can select preset 326-1, and every time the user wants to access address accessible information provided at “http://206.199.333.9000”, she can select 326-2. Likewise, because the preset is updated in the configuration data of the user's information file 417 on service provider 420, the next time the user accesses her account on service provider server 420, her account will reflect the changes she made to her presets. Head unit 322 further includes URL button 325 and download button 327, both of which will be explained in more detail below. In other forms of the present invention, the functionality of receiver 410 may be incorporated into head unit 322, 322′.

Again referring to FIG. 5, after the consumer listens to a jazz song or two, the consumer may decide at 540 to watch a national news broadcast on her favorite Internet television news station. Understanding that access to the news station may only be a few moments way, the consumer may press URL control button 325′ (FIG. 3B) on display monitor head unit 322′ to enable her use of an URL/text string already downloaded by receiver 410. In a fashion similar to that described above regarding the audio address accessible information, the consumer at 525 may select address accessible information for playback by using tuner control 324′ to sequentially move up or down through the listing of URLs/text strings displayed on head unit display panel 320′. When the consumer finds the URL/text string for the news station, e.g., information provider 412b, receiver 410 accesses the address accessible information at 530, and at 535, the consumer is able to view the address accessible information through vehicle's display monitor 322′.

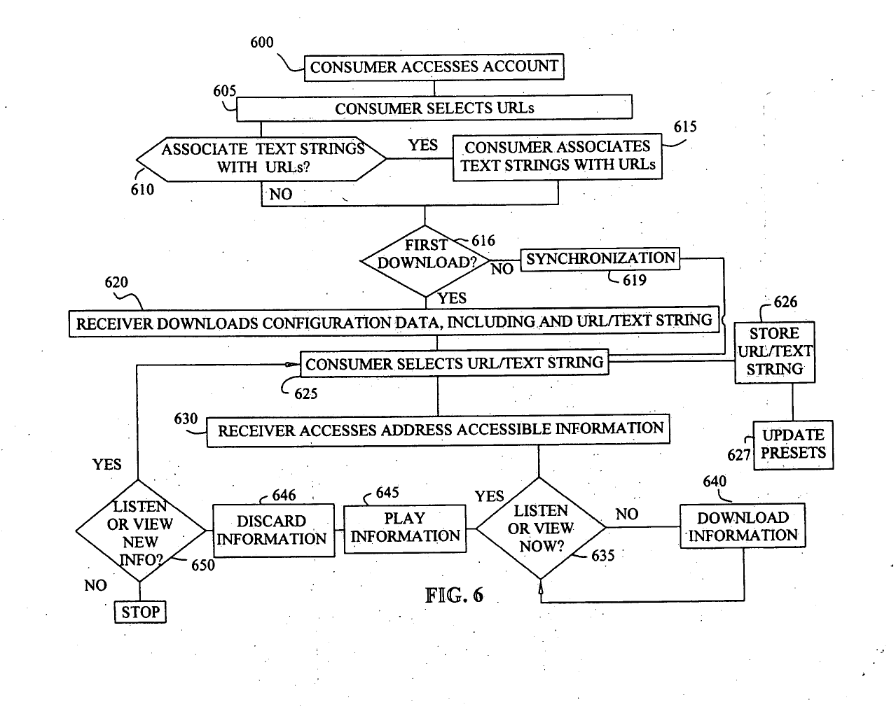

FIG. 6 is a flowchart illustrating the consumer's role in utilizing the address accessible information transmission system 400, including the functionality of an alternative-embodiment of the receiver of the present invention. After receiver 410 accesses the address accessible information at 630, the consumer has the choice at 635 to listen to the address accessible information then or later. If the consumer decides to listen to the address accessible information later, receiver 410 downloads the information at 640 for later playback. If the consumer decides to immediately listen to the address accessible information, receiver 410 plays the streaming address accessible information through the vehicle's speakers at 645.

In this embodiment of the receiver, receiver's 410 memory 226 (FIG. 2) is used to store the address accessible information until the consumer is ready to listen and/or view the information. For example, again referring to FIG. 6, the consumer may wish to listen at 635 to a song retrieved from a MP3 file stored on home server 416. Realizing that she is expecting a mobile phone call in the next couple of minutes, the consumer may decide not to listen to the song right away, in which case the consumer at 640 may activate the download process by pressing download button 327 (FIG. 3A), or any other similarly programmed button. Subsequently, when the consumer is ready to listen to the downloaded song, she may press URL button 325 and again use turner control 324 at 625 to locate the URL/text string associated with the consumer's MP3 file on home server 416. Upon adjusting tuner control 324 to the appropriate URL/text string, receiver 410 recognizes that the address accessible information has been downloaded and plays the address accessible information through the vehicle's speakers at 645.

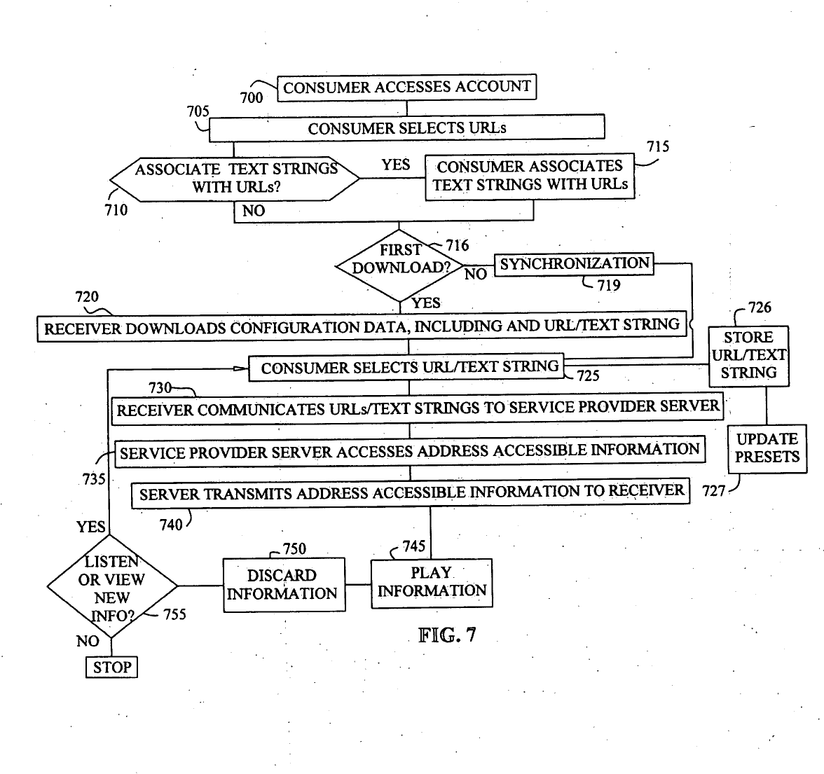

In another embodiment of address accessible information system 400, service provider server 420 facilitates receiver's 410 access to the address accessible information. Referring to FIG. 7, when the consumer finds the URL/text string for the desired address accessible information at 725, receiver 410 (FIG. 4) communicates the chosen URL/text string to service provider server 420 at 730, and at 735, server 420 uses the URL, or the text string associated with the URL, to access the desired address accessible information. Service provider server 420 then buffers and re-transmits the address accessible information to receiver 410 at 740, and receiver 410 plays the address accessible information through the vehicle's speakers at 745.

If the consumer decides at 755 to access different address accessible information, the consumer may press URL control button 325 on head unit 322 (FIG. 3A) to enable her use of the URL/text string already downloaded by receiver 410. The consumer at 725 may then use tuner control 324 to select address accessible information for playback by scrolling through the listing of URLs/text strings displayed on head unit 320. When the consumer finds the URL/text string for the desired new address accessible information, receiver 410 communicates the chosen URL/text string to service provider server 420 at 730, and at 735, server 420 uses the URL/text string to access the new address accessible information. Service provider server 420 then transmits the address accessible information to receiver 410 at 740, and the consumer is able to listen at 745 to the address accessible in formation through the vehicle's speakers.

While this invention has been described as having an exemplary design, the present invention may be further modified within the spirit and scope of this disclosure. This application is therefore intended to cover any variations, LSCS, or adaptations of the invention using its general principles. Further, this application is intended to cover such departures from the present disclosure as come within known or customary practice in the art to which this invention pertains.

We claim:

1. An address accessible information transmission system, the system comprising:
a server maintaining a specified address for address accessible information; and
a receiver in communication with said server, said receiver capable of retrieving the specified address, utilizing the address to access the address accessible information, and providing the address accessible information to the vehicle entertainment system.

2. The system of claim 1 wherein said server is connected to a globally accessible information interchange network.

3. The system of claim 1 wherein the specified address includes an URL.

4. The system of claim 3 wherein the specified address includes a text string associated with the URL.

5. The system of claim 1 wherein the address accessible information is audio data.

6. The system of claim 1 wherein the address accessible information is video data.

7. The system of claim 1 wherein said server and said receiver are in wireless communications.

8. The system of claim 1 wherein said receiver includes means for transmitting the address accessible information to the vehicle entertainment system.

9. An address accessible information transmission system for delivering address accessible information to a vehicle entertainment system, the system comprising:
a server capable of obtaining the address accessible information; and
a receiver in communication with said server, said receiver capable of both identifying desired address accessible information to said server and providing the address accessible information to the vehicle entertainment system.

10. The system of claim 9 wherein said server is connected to a globally accessible information interchange network.

11. The system of claim 9 wherein the desired address accessible information is associated with a specified address.

12. The system of claim 11 wherein the specified address includes at least one of an URL and a text string associated with an URL.

13. The system of claim 9 wherein the address accessible information is audio data.

14. The system of claim 9 wherein the address accessible information is video data.

15. The system of claim 9 wherein said server and said receiver are in wireless communications.

16. The system of claim 9 wherein said receiver includes means for transmitting the address accessible information to the vehicle entertainment system.

17. A receiver for use with an address accessible information transmission system including a server maintaining user data, the receiver including:
means for communicating with the server;
means for retrieving the user data from the server, the user data including a specified address for address accessible information; and
means for both utilizing the specified address to access the address accessible information and providing the address accessible information to a vehicle entertainment system.

18. The receiver of claim 17 wherein said specified address includes an URL.

19. The receiver of claim 18 wherein said specified address includes a text string associated with the URL.

20. The receiver of claim 19 wherein the receiver includes a head unit, the head unit having an interface enabling the vehicle occupant to select the specified address.

21. The receiver of claim 17 wherein the receiver includes means for transmitting the address accessible information to the vehicle entertainment system.

22. The receiver of claim 17 wherein the address accessible information is audio data.

23. The receiver of claim 17 wherein the address accessible information is video data.

24. The receiver of claim 17 wherein the receiver includes means for synchronizing the user data maintained in the server with the user data retrieved by the receiver.

25. The receiver of claim 24 wherein the user data includes user preset information.

26. In an address accessible information transmission system, a method of delivering the address accessible information to a vehicle entertainment system, the transmission system including a server in communication with a network and maintaining a specified address for address accessible information, the method comprising the steps of:
providing a receiver; and
utilizing the receiver to perform the steps of:
retrieving the specified address;
accessing the address accessible information using the specified address, the address accessible information streamed from an information provider server; and
providing the address accessible information to the vehicle entertainment system.

27. The method of claim 26 wherein the specified address includes an URL.

28. The method of claim 27 wherein the specified address includes a text string associated with the URL.

29. The method of claim 26 wherein the address accessible information includes audio data.

30. The method of claim 26 wherein the address accessible information includes video data.

31. The method of claim 26 wherein the utilizing step includes a step of receiving the streamed address accessible information.

32. The method of claim 31 wherein the step of providing the address accessible information includes a step of transmitting the address accessible information to the vehicle entertainment system.

33. The method of claim 32 wherein the step of transmitting includes a step of pausing the transmission of the address accessible information to the vehicle entertainment system at a first point in the address accessible information.

34. The method of claim 33 wherein the receiver may perform the step of pausing the transmission of the streamed address accessible information to the vehicle entertainment system concurrently with the step of receiving the streamed address accessible information.

35. The method of claim 34 wherein the step of transmitting includes a step of resuming the transmission of the streamed address accessible information to the vehicle entertainment system at a second point in the address accessible information different from the first point.
